(19) United States
(12) Patent Application Publication
(10) Pub. No.: US 2025/0147242 A1
(43) Pub. Date: May 8, 2025

(54) MICRO-FERRULE PRE-TERMINATED MICRO-CABLE FOR FIBER OPTIC NETWORKS

(71) Applicant: CORNING RESEARCH & DEVELOPMENT CORPORATION, Corning, NY (US)

(72) Inventors: Victor Julian Borer, Austin, TX (US); Davide Domenico Fortusini, Ithaca, NY (US); Vincent Yves Marius Goleret, Montpellier (FR); Gordon Mueller-Schlomka, Berlin (DE); Qi Wu, Painted Post, NY (US)

(21) Appl. No.: 18/938,445

(22) Filed: Nov. 6, 2024

Related U.S. Application Data
(60) Provisional application No. 63/547,434, filed on Nov. 6, 2023.

(51) Int. Cl. G02B 6/38; G02B 6/40

(52) U.S. Cl. CPC G02B 6/3839; G02B 6/3851; G02B 6/3882; G02B 6/403

(57) ABSTRACT

Micro-ferrules and pre-terminated micro-cable assemblies are disclosed. The micro-ferrules are configured for making and using cable assemblies in micro-ducts. The pre-terminated micro-cable assembly includes a main cable and one or more subunits that include a pre-selected number of optical fibers arranged within the main cable. Each of the one or more subunits includes at least a first end terminated with a micro-ferrule.

### RELATED APPLICATIONS

This application claims the benefit of priority of U.S. Provisional Application Ser. No. 63/547,434 filed on Nov. 6, 2023, the content of which is relied upon and incorporated herein by reference in its entirety.

### TECHNICAL FIELD

This disclosure relates generally to micro-ferrules and fiber optic cable assemblies pre-terminated with micro-ferrules for use with fiber optic networks, such as FTTx networks and the like.

### BACKGROUND

Optical fibers are used in a wide variety of applications, most commonly as part of the physical layer of a communication protocol through which network nodes communicate over a data network. Optical fibers offer several benefits, including wide bandwidth and low noise operation. A passive optical network (PON) is a type of optical distribution network that is comprised entirely of passive optical components. The continued growth of the Internet has resulted in a corresponding increase in demand for network capacity and reliability. This demand has, in turn, caused carriers to extend their PONs closer to end users. This extension of optical fiber toward the ends of the network (e.g., node, curb, building, home, etc.) is commonly referred to as Fiber-To-The-x (FTTx).

In one such network configuration, carriers desire to extend their PONs all the way to user workstations within office buildings. This type of extension of carrier PONs may be referred to as Fiber-To-The-Workplace (FTTW) or Fiber-To-The-Desk (FTTD). In another network configuration, carriers desire to extend their PONs all the way to network equipment in the home. This type of extension of carrier PONs may be referred to as Fiber-To-The-Home (FTTH). FTTH in particular has been recognized by governments around the world as an essential digital infrastructure to support economic growth across urban and rural areas. Presently, FTTH reaches less than 50% of homes in the United States. Equipping more homes with optical fibers will require innovative and lower-cost technologies for both dense urban and remote communities.

In such network configurations as those described above, homes and workplaces may be optically connected to network equipment by fiber optic cables that are routed through ductwork, such as microducts. The use of microducts for cable installation is becoming widespread as microtrenching is increasingly adopted for urban areas due to its lower cost, speed, and minimal disruption to street traffic. Microducts facilitate quick installation of fiber cable through jetting. To increase bandwidth, it is desirable to locate as many optical fibers through the ductwork as possible while also allowing installers to physically route the fiber optic cable through the ductwork.

Furthermore, to provide optical connectivity to homes and workplaces, the optical fibers of a main trunk cable are often spliced to optical fibers of drop cables that are coupled to the network equipment in a home or workplace. For this coupling, a splice cabinet may be fixedly positioned relatively close to where a fiber optic cable enters the home or workplace. The splice cabinet holds numerous splice trays, in which the optical connections are made, in a tray carriage positioned within the cabinet. For example, a fusion splicing technique is generally used to optically couple the optical fibers in the splice cabinet.

The amount of labor and time required for splicing together optical fibers, such as through a fusion splicing technique, is significant. This time and labor may be a hindrance to the development and growth of fiber optic networks (e.g., FTTx networks). Additionally, fusion splicing is a labor-intensive method for connecting optical fibers that is typically performed under field conditions, as opposed to under more highly controlled factory conditions. Thus, the quality of the splicing and the attenuation of the optical signal through the splice may vary widely depending on the field technicians' skill and experience. This may result in diminished and unpredictable quality and potentially remedial measures, which are time-consuming and costly.

Moreover, pre-terminated cable solutions for use with microducts have traditionally been limited by the lack of high-density and small-footprint connectors. Because commonly used microtrenching and aerial microducts have an inner diameter of e.g., 8 millimeters, and the cable may have an optical fiber count of about 144 optical fibers, MPO-based connectors cannot be accommodated in the microduct. Thus, traditional ways of field fusion splicing remain the only option for optically connecting cables routed through microducts in the field.

In view of the above, and as the pace of optical fiber demand accelerates, there is a growing need for high-density pre-terminated cable solutions that may be used with microducts.

### SUMMARY

The present application is directed to micro-ferrules and pre-terminated micro-cable assemblies terminated using the disclosed micro-ferrules. In one aspect of the disclosure, a pre-terminated micro-cable assembly is disclosed. The pre-terminated micro-cable assembly includes a main cable and one or more subunits that each include a pre-selected number of optical fibers arranged within the main cable. Each of the one or more subunits has a first end terminated with a micro-ferrule.

The micro-ferrules disclosed herein comprises a plurality of microholes arranged in a 2D array pattern at the front mating surface for receiving and terminating a plurality of the pre-selected number of optical fibers. The micro-ferrule comprises a maximum cross-sectional dimension less than or equal to 2.6 millimeters with at least two mating features having a diameter less than 0.60 millimeters arranged on opposite sides of the 2D array pattern, where the 2D array pattern comprising a pitch less than or equal to 200 micrometers (μm) between microholes. The micro-ferrule enables the installation of the micro-ferrule into suitable micro-ducts as desired while providing a high-density optical connector for the optical network.

In other embodiments, each of the one or more subunits may also have a second end terminated with a micro-ferrule. Furthermore, the micro-ferrules of the one or more subunits at either end section of the pre-terminated micro-cable assembly may be spaced apart in a staggered arrangement along the end section of the pre-terminated micro-cable assembly to facilitate a higher density of optical fibers carried by the pre-terminated micro-cable assembly without the need to increase the overall cross-sectional diameter, or lateral size, of the pre-terminated micro-cable assembly.

Also disclosed are micro-ferrules configured to terminate a plurality of optical fibers. In one embodiment, the micro-ferrule comprises a ferrule body that extends between a front surface and a rear surface with the micro-ferrule configured for receiving the plurality of optical fibers with a front mating surface that includes a plurality of microholes arranged in a 2D array pattern. The 2D array pattern may have any suitable arrangement for receiving and terminating a plurality of optical fibers. The micro-ferrule comprising a maximum cross-sectional dimension of less than or equal to 2.6 millimeters and at least two mating features having a diameter less than or equal to 0.60 millimeters arranged on opposite sides of the 2D array pattern, wherein the 2D array pattern comprising a pitch of less than or equal to 200 micrometers (μm), thereby enabling installation of the micro-ferrule into micro-ducts

The disclosure is also directed to a micro-ferrule configured to terminate at least one optical fiber. The micro-ferrule comprising a ferrule body that extends between a front surface and a rear surface and the ferrule body comprising a front mating surface that includes at least one microhole arranged in a 1D array pattern for receiving and terminating at least one optical fiber and the micro-ferrule comprising a maximum cross-sectional dimension of less than or equal to 2.6 millimeters and at least two mating features having a diameter less than or equal to 0.60 millimeters arranged on opposite sides of the 1D array pattern.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic view illustrating an exemplary FTTx carrier network in which embodiments of the disclosure may be used.

FIG. 2 is a schematic view of an exemplary FTTx network in a home.

FIG. 3 is a cross-sectional view of a pre-terminated micro-cable assembly in accordance with an embodiment of the disclosure.

FIG. 4A is a perspective view of a connectorized end of the pre-terminated micro-cable assembly of FIG. 3.

FIG. 4B is a cross-sectional view of the pre-terminated micro-cable assembly taken along line 4B-4B of FIG. 4A.

FIG. 5 is a perspective view of a micro-ferrule of one end of a subunit of the pre-terminated micro-cable assembly of FIGS. 3-4B.

FIG. 6 is a side view of the micro-ferrule of FIG. 5.

FIG. 7 is a front view of the micro-ferrule of FIGS. 5 and 6.

FIG. 8 is a schematic perspective view of the micro-ferrule of FIGS. 5-7.

FIG. 9A is a perspective view illustrating the connection of two micro-ferrules.

FIG. 9B is a front view of a micro-ferrule having a key-up polarity configuration.

FIG. 9C is a front view of a micro-ferrule having a key-down polarity configuration.

FIG. 10 is a perspective view of two micro-ferrules in a mated configuration being supported in a holder in accordance with an embodiment of the disclosure.

FIG. 11 is a perspective view of two pre-terminated micro-cables assemblies connected together and including one drop cable.

FIG. 12 is a perspective view of two pre-terminated micro-cables assemblies connected together and including one breakout harness to configure the number of drop optical fibers in accordance with an embodiment of the disclosure.

FIG. 13A is a perspective view of the breakout harness of FIG. 12 in accordance with an embodiment of the disclosure.

FIG. 13B is an end view of an input micro-ferrule of the breakout harness of FIG. 13A.

FIGS. 13C and 13D are end views of output micro-ferrules of the breakout harness of FIG. 13A.

FIG. 14 is a schematic view of a multi-drop fiber distribution network using pre-terminated micro-cable assemblies in accordance with an embodiment of the disclosure.

FIGS. 15A and 15B depict a profile of another micro-ferrule disposed in a micro-duct along with a perspective view of the front end of the micro-ferrule of FIG. 15A.

FIGS. 16A and 16B depict a profile of still another micro-ferrule disposed in the micro-duct along with perspective views of the front end of the micro-ferrule of FIG. 16A that is similar to the micro-ferrule of FIGS. 15A and 15B.

FIG. 17 depicts a profile of yet another micro-ferrule that is similar to the micro-ferrule in FIGS. 16A and 16B with a taller profile.

FIGS. 18A and 18B depict a profile of a further micro-ferrule for use in cable assemblies along with a perspective view of the front end of the micro-ferrule of FIG. 18A.

FIGS. 19A and 19B depict front and rear perspective views of another profile for a micro-ferrule having a different number of fiber bores in one or more adjacent rows of the array of fiber bores.

FIGS. 20A and 20B depict a profile of still another micro-ferrule disposed in a duct along with a perspective view of the front end of the micro-ferrule of FIG. 20A.

### DETAILED DESCRIPTION

Various embodiments will be further clarified by examples in the description below. In general, the description relates to micro-ferrules and a fiber optic micro-cable that is pre-terminated with the micro-ferrules, and methods of installing and using same. The pre-terminated micro-cable assembly includes a plurality of optical fibers, which may be arranged in subunits within a main fiber optic cable, and which have at least one end pre-terminated or connectorized one or more micro-ferrules. The micro-cable assemblies may be a portion of micro-cable distribution network. The micro-ferrules are smaller in size compared with conventional ferrules. These smaller micro-ferrules disclosed herein allow the use of the micro-ferrule in application spaces where conventional ferrules such as MT or TMT ferrules are too large to work. For instance, the micro-ferrules allow the manufacture of terminated cable assemblies that may be installed into micro-ducts such as micro-ducts having an inner diameter of about 4 millimeters where conventional ferrules are too large.

Besides using micro-ferrules, the cable assemblies may have other features for creating a relatively small cross-sectional dimension for cable assemblies. To reduce the overall cross-sectional diameter, or lateral size, of the fiber optic micro-cable assembly, the micro-ferrules at each end section of the micro-cable assembly may be staggered apart to form a staggered ferrule arrangement (referred to in this disclosure as a “ferrule train”). As a result, the cross-sectional diameter of the micro-cable assembly at any position along its length in the end section is no greater than a diameter of the outer sheath of the main fiber optic cable. For example, each micro-ferrule may have a maximum dimension or diameter of approximately 2.5 millimeters or less and the outer diameter of the outer sheath of the main fiber optic cable of the pre-terminated micro-cable assembly may be approximately 6.3 millimeters or less. For example, existing multifiber ferrules (e.g., MT ferrules for MPO connectors or reduced MT-style ferrules for very small form factor connectors, such as MMC connectors or SN-MT connectors) have a width of at least 6.5 millimeters, making them too large fit within the high fiber count micro-cables. The staggered arrangement allows for multiple, such as six or more, subunits connected with micro-ferrules to be arranged within the main fiber optic cable of the pre-terminated micro-cable assembly, thereby enhancing the optical fiber density of the micro-cable assembly. That is, the pre-terminated micro-cable assembly may include multiple micro-ferrules at one or both end sections thereof, but as a result of the staggered arrangement of the micro-ferrules, the diameter of the pre-terminated micro-cable assembly remains 6.3 millimeters or less along the length of the end section(s) having the micro-ferrules (and potentially along an entire length of the pre-terminated micro-cable assembly). As a result, the pre-terminated micro-cable may include a significant number of pre-terminated subunits (i.e., a high-density of optical fibers), yet still be routed through microducts having an inner diameter anywhere between about 3 millimeters (millimeters) and about 16 millimeters, for example, as well as be optically connected to like connectorized cables in small spaces, such as a closure or other terminal that is less than 76 millimeters (3 inches) wide and less than 152 millimeters (6 inches) long, for example. In one particular advantageous embodiment the preterminated micro-cable assembly is suitable for use in a duct having an inner diameter of about 4 millimeters. These and other benefits of the disclosure will be described in additional detail below.

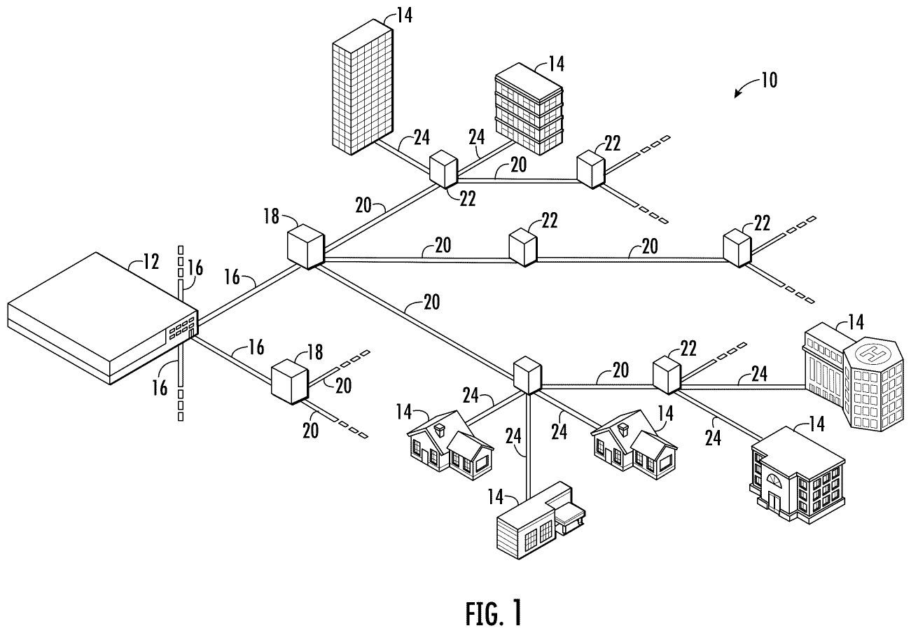

Referring now to the Figures, FIG. 1 depicts an exemplary FTTx carrier network 10 that distributes optical signals generated at a switching point 12 (e.g., a central office) to one or more subscriber premises 14. Optical line terminals (OLTs—not shown) at the switching point 12 convert electrical signals into optical signals. Fiber optic feeder cables 16 then carry the optical signals to various local convergence points 18. The convergence points 18 act as locations for making cross-connections and interconnections (e.g., by splicing or patching cables). The local convergence points 18 often include splitters or WDM components to enable any given optical fiber in the feeder cable 16 to serve multiple subscriber premises 14. As a result, the optical signals are “branched out” from the optical fibers of the feeder cables 16 to optical fibers of fiber optic distribution cables 20 that exit the local convergence points 18.

At remote network access points 22 closer to the subscriber premises 14, some or all of the optical fibers in the distribution cables 20 may be accessed to connect to one or more subscriber premises 14. Drop cables 24 extend from the network access points 22 to the subscriber premises 14, which may be single-dwelling units (SDU), multi-dwelling units (MDU), businesses, and/or other facilities or buildings. An optical network terminal (ONT—not shown) located at or inside the subscriber premises 14 receives one or more optical signals and converts the optical signals back to electrical signals at the remote distribution points or subscriber premises 14.

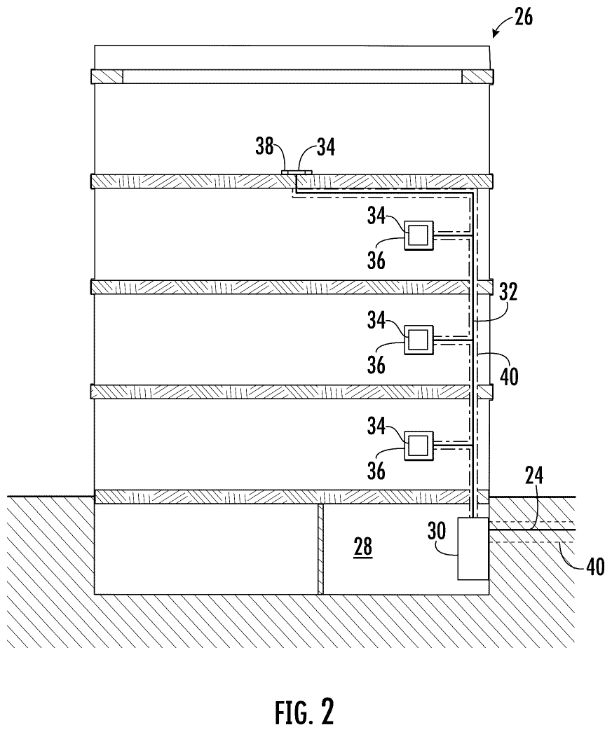

One embodiment of an FTTx network is a FTTH network, which provides optical fiber to a home, such as a single-dwelling unit (SDU), a multi-dwelling unit (MDU), or the like. FIG. 2 illustrates an exemplary MDU 26. As illustrated in FIG. 2, the drop cable 24 from a network access point 22 generally enters the MDU 26 at a basement or lower floor having a room 28 with one or more cabinets, closures, or other terminals 30 for holding network equipment (not shown). Fiber optic cables 32 connect the network equipment in the one or more terminals 30 to network equipment 34 associated with various subscribers throughout the MDU 26. By way of example and without limitation, the network equipment 34 may include wall panels 36 on the various levels of the MDU 26 and/or floor panels 38.

To protect the cables 24, 32 from damage during installation, construction, and general maintenance, the cables 24, 32 are typically enclosed in ductwork 40 (shown in phantom in FIG. 2), such as microducts, that defines pathways between the remote network access point 22 and the MDU 26, for example. Further, the ductwork 40, such as microducts, may define pathways from the room 28 into which cables 24 enter the MDU 26 and the network equipment 34 within the MDU 26, as shown. Microducts are generally small ducts or tubes having a diameter anywhere between about 3 millimeters (millimeters) and about 16 millimeters that are configured to receive at least one fiber optic cable therethrough. To that end, microducts may be installed underground via micro-trenching technique, aerially, or in buildings. To that end, any of the fiber optic cables 20, 24, 32 may be routed through the ductwork 40, such as microducts, for connection at local convergence points 18, network access points 22, terminals 30, and/or network equipment 34, for example. As described in more detail below, one or more fiber optic cables 20, 24, 32 may be pre-terminated with one or more micro-ferrules sized and arranged to permit the fiber optic cables 20, 24, 32 to be effectively routed through ductwork 40 that may be in the form of microducts.

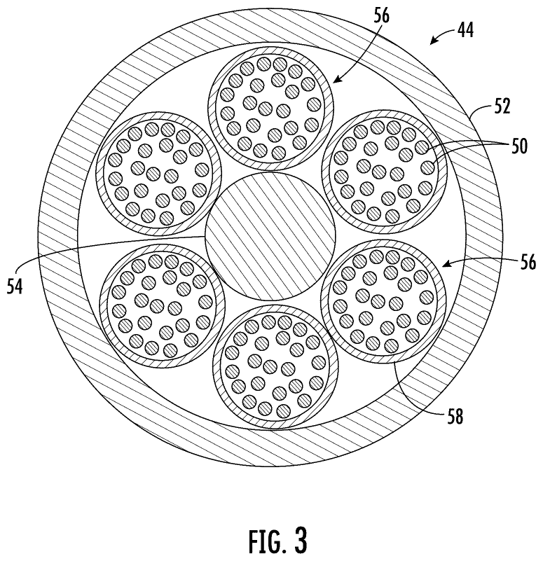

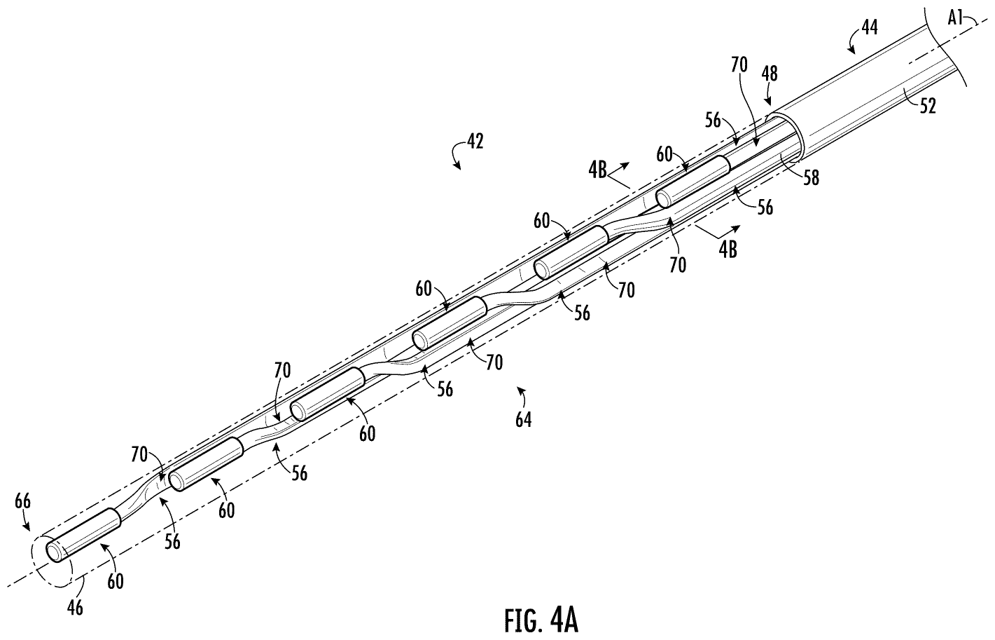

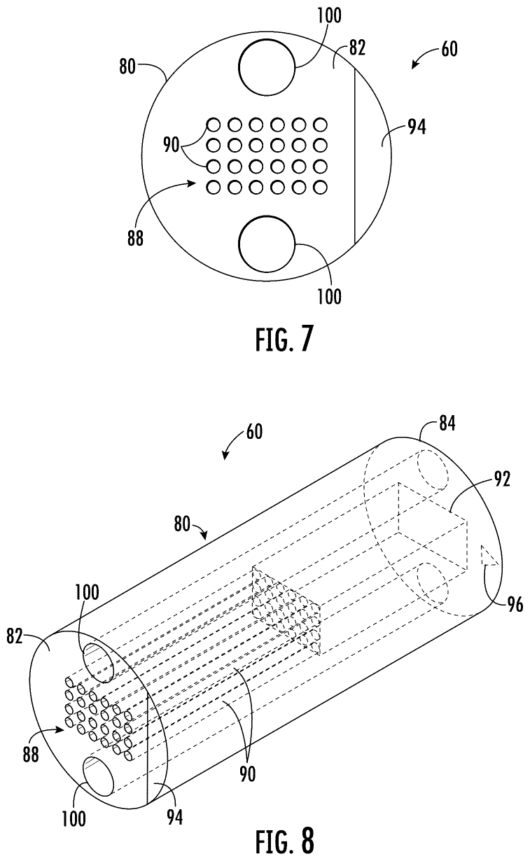

FIGS. 3-14 illustrate a pre-terminated micro-cable assembly, otherwise referred to as micro-cable assembly 42, in accordance with exemplary embodiments of the disclosure. The micro-cable assembly 42 may be representative of any of the fiber optic cables 20, 24, 32 described above, for example. As shown in FIG. 4A, the micro-cable assembly 42 may include a main fiber optic cable 44 and an installation grip 46 connected to an end 48 of the main fiber optic cable 44. The installation grip 46, sometimes referred to as a pulling grip or pulling sock, facilitates routing of the fiber optic cable 44 along pathways defined by ductwork 40, such as microducts, for example. As shown in FIGS. 3-4B, the fiber optic cable 44 includes a plurality of optical fibers 50 carried within a main cable sheath or jacket 52. By way of example and without limitation, the fiber optic cable 44 may carry 144 optical fibers 50. It should be appreciated, however, that the fiber optic cable 44 may include more or less optical fibers 50, such as 96, 288, or 432 optical fibers 50, for example, and remain within the scope of the present disclosure.

As shown in FIG. 3, the fiber optic cable 44 further includes at least one strength member 54 extending along the length of the fiber optic cable 44 to accommodate tensile loading of the fiber optic cable 44. In other words, instead of tensile loads on the fiber optic cable 44 being borne by the optical fibers 50, and possibly damaging the optical fibers 50, the tensile loads are borne by the at least one strength member 54, thereby minimizing damage to the optical fibers 50. The at least one strength member 54 may include glass reinforced polymer rods, steel rods, aramid yarns, or the like. In one embodiment, the at least one strength member 54 may extend along the plenum defined by the outer jacket 52 of the fiber optic cable 44. Alternatively, the at least one strength member 54 may be incorporated within the outer jacket 52 itself. In one embodiment, for example, the fiber optic cable 44 may include two or more strength members 54. However, other numbers and arrangements of strength members 54 may be possible.

Referring to FIGS. 3-4B, the fiber optic cable 44 includes a plurality of subunits 56 arranged within the outer protective sheath 52 of the main fiber optic cable 44. Each subunit 56 is configured to carry a pre-selected number of optical fibers 50. Although the fiber optic cable 44 is shown as including six subunits 56 (e.g., FIG. 3), the number of subunits 56 may be more or less than this number in alternative embodiments, such as 4, 12, 24, or 36 subunits 56, for example. By way of example and without limitation, the outer diameter of the outer protective sheath 52 of the main fiber optic cable 44 may be about 6.3 millimeters. In the embodiment shown, each of the subunits 56 is configured to carry 24 optical fibers 50, for example. However, it should be recognized that more or less optical fibers 50 may be carried by each of the subunits 56. The optical fibers 50 of a subunit 56 may be arranged within a subunit sheath or membrane 58, as shown, which may be a thin layer of material that has been extruded over the optical fibers 50.

With reference to FIG. 4A, the micro-cable assembly 42, and in particular each subunit 56 may be pre-terminated or connectorized at each end with one or more micro-ferrules 60 in accordance with embodiment of the present disclosure. Although only one end of the micro-cable assembly 42 (and each subunit 56) is shown, it will be understood that an opposite, second end of the micro-cable assembly 42 (and each subunit 56) may be similarly configured. Thus, each subunit 56 may include two micro-ferrules 60 (one on each end thereof). Micro-ferrules 60 may terminate any suitable number of optical fibers 50 as desired such as one or more optical fibers.

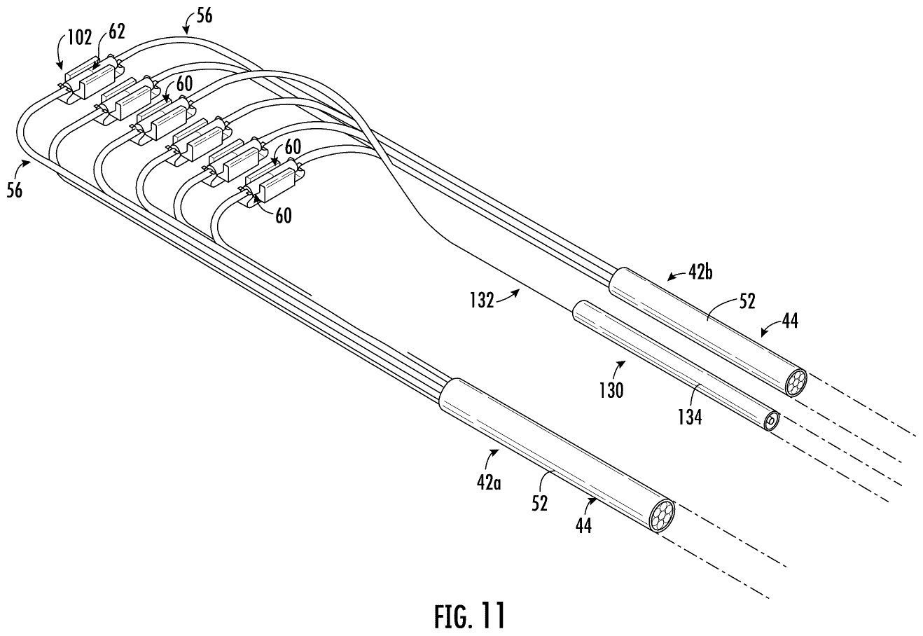

By way of example and without limitation, at least one of the ends of each subunit 56 may be terminated with a micro-ferrule 60 that is configured to receive, for example, 24 optical fibers 50. Thus, in the embodiment shown, each subunit 56 includes 24 optical fibers, terminated at one or both ends thereof by a micro-ferrule 60, thereby providing 144 optical fibers 50 in the fiber optic cable 44 of the micro-cable assembly 42. It should be understood that the number of optical fibers 50 in each subunit 56 and terminated by each micro-ferrule 60 and the number of subunits 56 associated with each micro-cable assembly 42 may vary. The size, shape, and organization of each micro-ferrule 60 within the micro-cable assembly 42 is configured to minimize space requirements, enabling relatively simple and cost-effective optical connections between adjacent micro-ferrules 60 of another micro-cable assembly 42 across a connection joint 62 (e.g., FIG. 10), as described in additional detail below.

With continued reference to FIG. 4A, the six subunits 56 of the micro-cable assembly 42 are arranged within the main fiber optic cable 44 so that the micro-ferrule 60 of each subunit 56 at the end of the micro-cable assembly 42 is spaced apart in a staggered arrangement, otherwise referred to as a micro-ferrule train 64. The micro-ferrules 60 are spaced apart so as to be in a staggered arrangement at one or both ends of the micro-cable assembly 42. As shown, each micro-ferrule 60 of one subunit 56 is spaced from an adjacent micro-ferrule 60 of another subunit 56 in a direction along a longitudinal axis A1 of the micro-cable assembly 42. Spacing between each micro-ferrule 60 may be distance of about 10 millimeters, for example. The total length of the micro-ferrule train 64 may be less than 110 millimeters, for example. In the embodiment shown, the micro-ferrules 60 are arranged generally in an end-to-end arrangement. That is, the micro-ferrule 60 of a first subunit 56 is arraigned generally in front (i.e., closer to an end 66 of the micro-cable assembly 42) of a second micro-ferrule 60 of an adjacent, second subunit 56, and so on. As a result, the micro-ferrules 60 of all 6 subunits 56 are capable of fitting within the sheath 52 of the main fiber optic cable 44.

Each micro-ferrule 60 may have a maximum cross-sectional dimension or maximum cross-sectional diameter of approximately 2.6 millimeters or less. In one embodiment, two micro-ferrules 60 may be positioned side-by-side and still fit within the sheath 52 of the main fiber optic cable 44, which has a cross-sectional diameter of approximately 6.3 millimeters or less. As shown in FIG. 4B, the micro-ferrules 60 may be spaced radially inward from the outer sheath 52 of the main fiber optic cable 44 to allow the subunit sheaths 58 of subunits 56 having more distally arranged micro-ferrules 60 (e.g., pass-through subunits 56) to extend past the micro-ferrule(s) 60 of more proximally arranged subunits 56, as will be described in further detail below. By distally arranged, it is meant a micro-ferrule 60 is positioned closer to the end 66 of the micro-cable assembly 42. By proximally arranged, it is meant a micro-ferrule 60 is positioned further from the end 66 of the micro-cable assembly 42 and closer to the sheath 52 of the main fiber optic cable 44.

As shown in FIG. 4A, the micro-ferrule train 64 is exposed from the sheath 52 of the main fiber optic cable 44. In that regard, the ferrule train 64 is configured to be enclosed by the installation grip 46. That way, the installation grip 46 may be removed from the end 48 of the main fiber optic cable 44 to thereby expose the micro-ferrule 60 of each subunit 56 for connection. The installation grip 46 is configured to transfer tension on the installation grip 46 to the main cable 44, and more particularly to the at least one strength member 54 thereof, along a load path that effectively bypasses the micro-ferrules 60 and the optical fibers 50 terminated by the micro-ferrules 60 of each subunit 56. The length of the installation grip 46 (and generally the micro-ferrule train 64) may be between about 100 millimeters and about 200 millimeters, for example. A diameter of the installation grip 46 may be no more than an outer diameter of the pre-terminated micro-cable assembly 42, for example.

As briefly described above, the subunit sheath 58 of subunits 56 having more distally arranged micro-ferrules 60 are configured to extend past the micro-ferrule(s) 60 of more proximally arranged subunits 56. This configuration is shown in FIG. 4B, which illustrates a cross-section of the micro-cable assembly 42 taken along line 4B-4B of FIG. 4A. In that regard, FIG. 4B illustrates an exemplary arrangement of the subunits 56 about the proximal-most micro-ferrule 60 of one subunit 56. As shown, the subunit sheath 58 of the remaining five subunits 56 is generally positioned in a space 68 defined between the micro-ferrule 60 and an internal diameter of the sheath 52 of the main fiber optic cable 44. The space 68 may be defined by the installation grip 46, for example. As shown, the exemplary micro-ferrule 60 may be spaced from the sheath 52 of the main fiber optic cable 44, but remain in a first half (e.g., upper half) of the space 68 to provide room in a second half (e.g., lower half) of the space 68 for the five subunits 56 routed past the micro-ferrule 60. To improve space utilization, the cross-section of a portion 70 of each subunit sheath 58 that is exposed from the sheath 52 of the main fiber optic cable 44 may have a non-circular cross-section, as shown in FIGS. 4A and 4B. This is in comparison to the generally circular cross-sectional shape each subunit sheath 58 within the sheath 52 of the main fiber optic cable 44 shown in FIG. 3. As shown, the exposed portion 70 of one or more subunit sheaths 58 may have a polygonal cross-sectional shape, such as trapezoidal. The exposed portion 70 of other subunit sheaths 58 may also have a polygonal cross-sectional shape, or be wedge-shaped or tapered, particularly those that extend into the half of the space 68 where the micro-ferrule 60 is located. However, the exposed portion 70 of each subunit sheath 58 may have any suitable cross-sectional shape, such as circular or non-circular, for example.

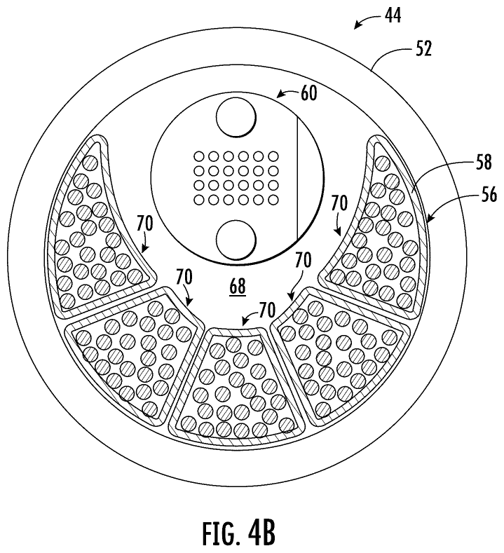

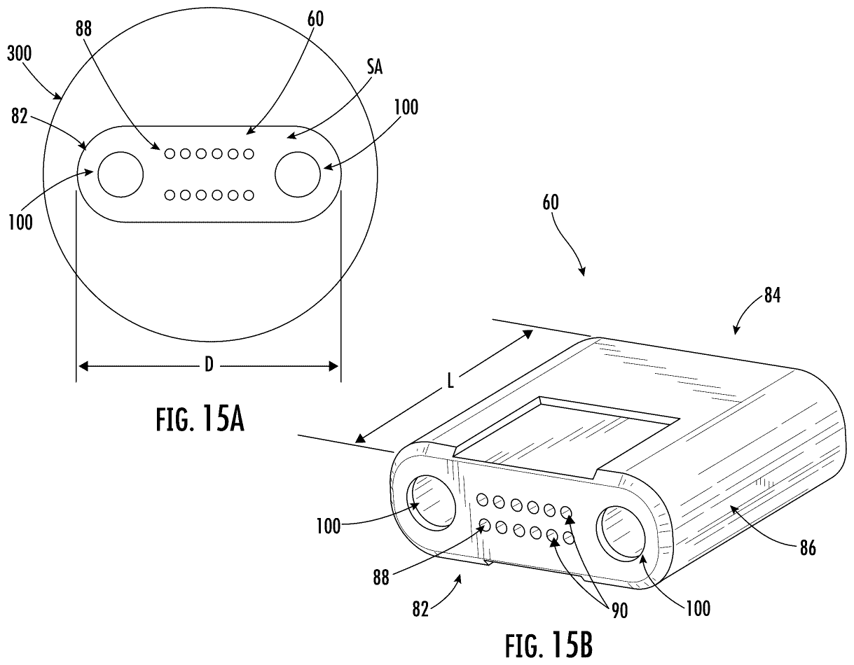

Likewise, the micro-ferrules 60 according to the concepts disclosed may have any suitable cross-sectional shape including round or non-round. With reference to FIGS. 5-9C, additional details of the micro-ferrules 60 are shown and will now be described having generally round cross-sections. FIGS. 15A-20B depict micro-ferrules 60 having non-round cross-sections according to the concepts disclosed. Micro-ferrules 60 may terminate any suitable number of optical fibers. For instance, micro-ferrules 60 may terminate at least 24 optical fibers. Micro-ferrules 60 are described in further detail herein.

Each respective micro-ferrule 60 includes a ferrule body 80 having a generally planar front surface 82, a rear surface 84, and one or more side walls 86 extending between the front and rear surfaces 82, 84. As shown in FIGS. 5-9A, the body 80 is generally cylindrical so as to have a generally circular outer profile shape, as illustrated, but other suitable shapes for the body 80 are possible such as shown in FIG. 15A-20B. In the embodiment of FIG. 5, the cross-sectional diameter of the body 80 is approximately 2.6 millimeters or less, but other dimensions are possible for the maximum cross-sectional dimension. For instance, a maximum diameter of the micro-ferrule may be 2.5 millimeters or less. The body 80, however, may have a square, rectangular or other regular cross-sectional profile, with or without rounded corners at the intersection between adjacent sides. Micro-ferrule 60 comprises a front mating surface having a suitable defined surface area. By way of example, the front mating surface may have a surface area of 4 square millimeters or less as desired. The body 80 may be formed using an injection molding process with glass filled polyphenylene sulfide (PPS) or other polymer material, for example.

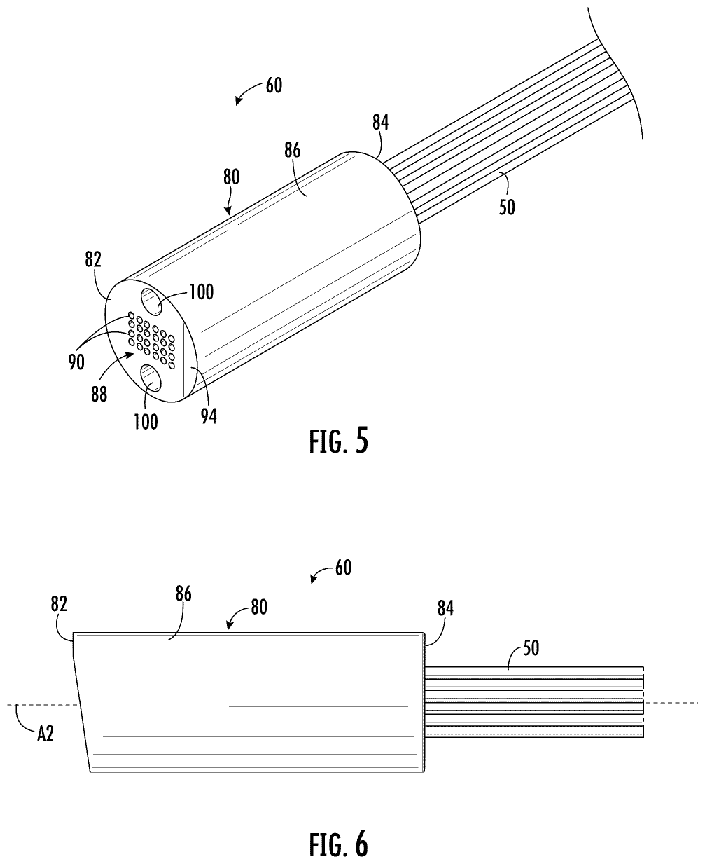

The body 80 generally defines a longitudinal axis A2 along a length or longitudinal direction of the body 80 between the front and rear surfaces 82, 84. In one embodiment, the front surface 82 may be generally perpendicular to the longitudinal axis A2. In the embodiment shown in FIG. 6, a portion of the front surface 82 may be non-orthogonally angled relative to the longitudinal axis A2. By way of example and without limitation, in this embodiment a portion of the front surface 82 may be angled about 8° relative to the longitudinal axis A2. Other angles may also be possible. The rear surface 84 of the body is typically perpendicular to the longitudinal axis A2, as shown. Thus, the front and rear surfaces 82, 84 may be generally non-parallel relative to each other. However, in an alternative embodiment, the front and rear surfaces 82, 84 may be parallel to each other. The length (L) of the body 80 in the direction of the longitudinal axis A2 may be between about 0.5 millimeters and about 10 millimeters, preferably between about 0.5 millimeters and about 5 millimeters, and even more preferably about 1 millimeter. Other suitable values of length (L) may also be possible.

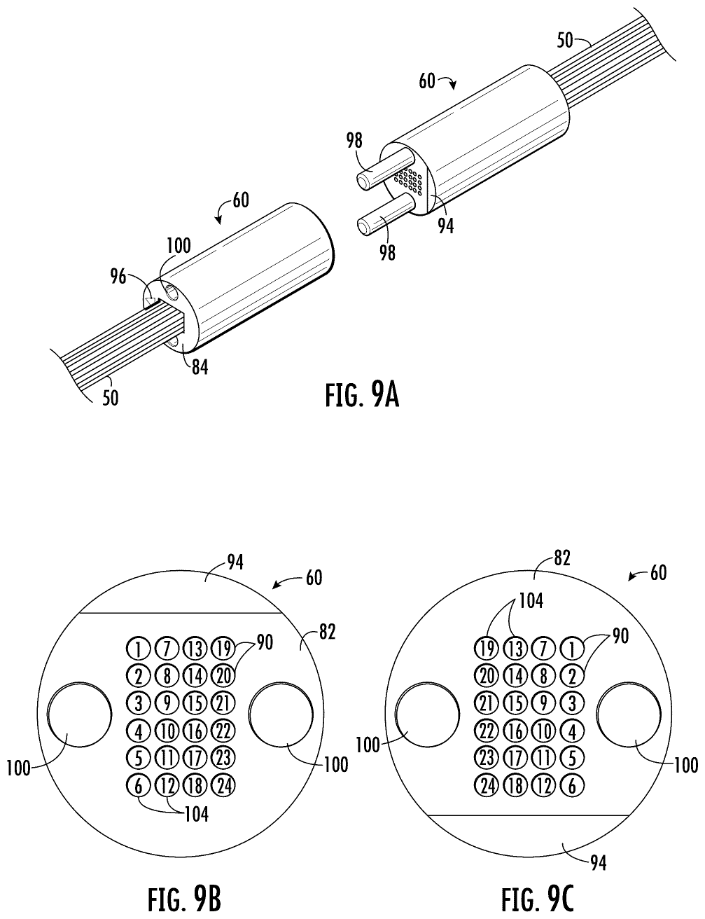

As shown, the body 80 of the micro-ferrule 60 includes an array 88 of microholes or fiber bores 90 (“bores 90”) formed through the body 80 from a cavity 92 in the rear rear surface 84 (e.g., FIG. 8) to the front surface 82, wherein each bore 90 is configured to receive an optical fiber 50 therein.

The cavity 92 in the rear surface 84 of micro-ferrule 60 accommodates all the coated fibers 50 (e.g., 24 optical fibers 50) being received into the bores 90. Furthermore, the cavity 92 may include suitable lead-in features, such as a chamfer or countersink, for example, that creates a funnel feature to facilitate insertion of the optical fibers 50 into the bores 90. The funnel feature that guides the insertion of the optical fibers may be 1 millimeter to 5 millimeters long depending on the design of the micro-ferrule 60. Other variations may include bores 90 that may be 1 millimeter to 3 millimeter long with a suitable taper of the bores 90 depending on the design and/or length (L) of the micro-ferrule 60.

The front surface 82 of the micro-ferrule 60 may further include a marker 94 that corresponds to a marker 96 on the rear face 84 to indicate the orientation of the angled portion of the front face 82, otherwise referred to as the key or angle orientation, as will be described in further detail below.

The array 88 provided in the body 80 may be one dimensional (1D) or two dimensional (2D) and be arranged in a certain geometrical configuration or pattern. For example, for one-dimensional arrays 88, the bores 90 may be vertically or horizontally arranged and may include a single bore for a single fiber if desired. A one-dimensional diagonal arrangement may also be possible. For two-dimensional arrays 88, the outline of the array 88 may be generally square, rectangular, circular, hexagonal, or other regular or irregular shapes as desired. The micro-ferrule 60 may comprise a 2D array pattern comprising any suitable arrangement. For instance, the 2D array pattern may have at least two rows or two columns of microholes or bores 90 for receiving and terminating a plurality of optical fibers of the respective subunit of the cable. Other variations of the 2D array pattern may have at least four rows or four columns of microholes or bores 90 for receiving and terminating a plurality of optical fibers of the respective subunit of the cable. In the exemplary embodiment of FIG. 5, the array 88 provided in the body 80 is a 2D array of 6×4 to minimize the aspect ratio. Other 2D array patterns may comprise at least six rows or at least six columns of bores 90 as desired.

The 1D or 2D array pattern of the micro-ferrule may comprise a pitch less than or equal to 200 micrometers (μm) as desired for the application. The pitch of the optical fibers 50 in the embodiment shown in FIG. 5 is approximately 200 micrometers (μm), matching that of the commonly used smaller coating diameter optical fibers (e.g., Corning® SMF-28@ Ultra 200 optical fibers). However, the pitch for the 1D or 2D array pattern may be smaller, such as 165 μm or 145 μm, for example, to match the optical fiber 50 coating diameter of the desired optical fibers 50. Using a smaller pitch may advantageously result in a smaller micro-ferrule 60 as well.

In an explanatory embodiments, the fiber bores 90 may have a nominal diameter that is sized to be slightly greater than the nominal size of the optical fibers 50 that are configured to be received in the bores 90 (e.g., after removing one or more coatings from bare glass portions of the optical fibers 50). The diameter of the bore 90 may be generally constant from the cavity 92 formed in the rear surface 84 to the front surface 82 of the body 80 or not as desired. Additionally, the bores 90 generally define a bore centerline that may in one embodiment be substantially parallel to the longitudinal axis A2 of the body 80. In an alternative embodiment, the centerline of the fiber bores 90 may be angled relative to the longitudinal axis A2 of the body 80 so as to be in non-parallel relation to the longitudinal axis A2.

To terminate a group of optical fibers 50 with a micro-ferrule 60, the group of optical fibers 50 may first be stripped and cleaved in accordance with methods known to those of ordinary skill in the art. The ends of the optical fibers 50 may then be inserted into the fiber bores 90 via the cavity 92 in the rear surface 84 of the body 80 of the micro-ferrule 60. The optical fibers 50 may then be inserted through the bores 90 until a small length of each optical fiber 50 projects beyond the front surface 82 of the body 80. The lead-in feature (i.e., chamfer or taper) formed in the fiber bores 90 at the cavity 92 in the rear surface 84 may facilitate the insertion of the optical fibers 50 into the respective bores 90. The optical fibers 50 may then be secured to the micro-ferrule 60. For example, an adhesive, such as an ultra-violet light curable adhesive, epoxy adhesive, thermoplastic adhesive, etc., may be applied to the micro-ferrule 60, including along the inner diameter of the bores 90, and then cured to bond the optical fibers 50 to the body 80 of the micro-ferrule 60.

In a subsequent processing step, if necessary, the small lengths of the optical fibers 50 that project beyond the front surface 82 of the body 80 are cleaved so that ends of the optical fibers 50 are closer to the front surface 82. The front surface 82 of the micro-ferrule 60 may then be polished to provide the front surface 82 with a desired geometry for serving as a mating interface. The front mating surface of the micro-ferrule may have any suitable surface area and will depend on the design of the micro-ferrule. In some embodiments, the front surface 82 may be polished prior to a termination process such that the micro-ferrule 60 is “pre-polished” and such that polishing during the termination process can be reduced or eliminated. Polishing devices and processes are generally well known in the fiber optic industry and a further description of such a process will not be further described herein.

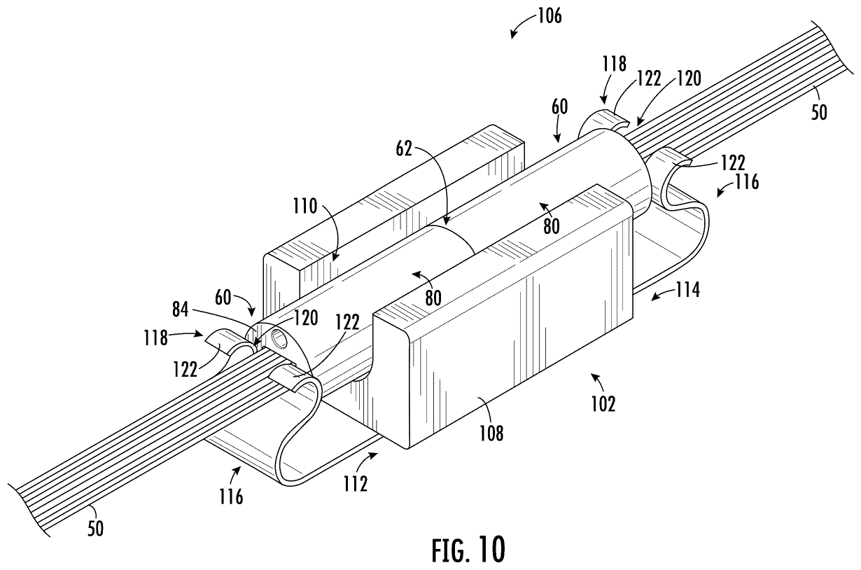

Suitable micro-ferrules 60 may be mated using a suitable structure. For instance, to aid in mating two micro-ferrules 60 together at a connection joint 62, each micro-ferrule 60 may include one or more mating features, generally shown at 98 and 100 (e.g., see FIGS. 8-9C), that facilitate the proper alignment of the opposing micro-ferrules 60 that are brought together at a connection joint 62 (e.g., FIG. 10). A specific alignment of the micro-ferrules 60 may be necessary depending on, for example, the particular arrangement of the fiber bores 90. The purpose of the mating features 98, 100 is to ensure core-to-core alignment of the optical fibers 50 across the connection joint 62 between micro-ferrules 60. In other words, the fiber bores 90 in the micro-ferrules 60 must be in axial alignment. Excellent axial alignment across the connection joint 62 between micro-ferrules 60 reduces optical losses across the connection joint 62 and throughout the optical fiber link path in general, which may include many connection joints 62.

In an exemplary embodiment, each of the micro-ferrules 60 may include two mating features 98, 100. For example, the micro-ferrule 60 at one end of a subunit 56 may include male mating features 98 and micro-ferrule 60 at the other end of the subunit 56 may include female mating features 100, as illustrated in FIGS. 5 and 9A. The male mating features 98 include some type of projection, such as an elongate pin, and the female mating features 100 include some type of receiver, such as an elongate bore (“mating bores 100”). The mating bores 100 may be larger than the fiber bores 90. The mating bores 100 may be through bores or blind bores open to the front surface 82 of the micro-ferrules 60. The elongate guide pin 98 may have a shape similar to that of the mating bores 100 but be sized just slightly smaller than the mating bores 100. For example, the elongate pin 98 may have a diameter of approximately 0.60 millimeters or less.

Referring to FIG. 9A, when two micro-ferrules 60 are brought together in the proper alignment (e.g., alignment of longitudinal axes A2 and orientations relative to those axes A2), the male feature 98 on one micro-ferrule 60 is configured to be received in the female feature 100 on the opposed micro-ferrule 60. This ensures, for example, a desired position of the micro-ferrules 60 relative to each other at which the micro-ferrules 60 may be mated. The micro-ferrules 60 are configured for physical contact and selective coupling and decoupling. Unlike permanent coupling (i.e., a single mating cycle), the micro-ferrules 60 may be coupled and decoupled to different micro-ferrules 60 later, for example. In that regard, a holder 102 (e.g., FIG. 10) is employed to maintain the mating condition between the micro-ferrules 60, as will be described in further detail below. However, for applications requiring only a few mating cycles over the service life of the micro-ferrules 60 and associated subunit 56, index matching gel or solid state index matching polymer film, for example, may be used in lieu of relying solely upon physical contact connection.

With reference to FIGS. 9A-9C, to ensure proper polarity when mating two micro-ferrules together, the micro-ferrules 60 must be coupled together with the correct key orientation. Polarity refers to the orientation of the optical fibers 50 within the micro-ferrule 60. It is important to maintain correct polarity when mating two micro-ferrules 60 together to ensure that the light signals are transmitted and received correctly across the connection joint 62 between micro-ferrules 60. In an exemplary embodiment, polarity of the micro-ferrule 60 at each end of a subunit 56 is managed using the markers 94, 96 described above. Each micro-ferrule 60 has two polarity configurations: a key-up configuration (shown in FIG. 9B) and a key-down configuration (shown in FIG. 9C). To that end, FIGS. 9B and 9C illustrate a key-up and a key-down configuration, respectively. Fiber numbers 104 indicate the position of optical fibers 50 relative to the marker 94 on the front surface 82 of each micro-ferrule 60. For example, the micro-ferrule 60 at the first end of a subunit 56 may include a key-up polarity configuration and the micro-ferrule 60 at the second end of the subunit 56 may include a key-down polarity configuration. To that end, a key-up polarity configuration of a micro-ferrule 60 is to receive optical fibers 50 from an upstream source while a key-down configuration is to connect to optical fibers 50 to a downstream source.

As shown in FIG. 9A, the micro-ferrules 60 are mated in a key-up to key-down configuration to ensure that optical fibers 50 pass straight through the connection joint 62. That is, the micro-ferrules 60 are mated together with one micro-ferrule 60 in the key-up position and the other micro-ferrule 60 in the key-down position. When mated in the key-up to key-down configuration, the markers 94, 96 may be positioned on opposite sides of the micro-ferrules 60, as shown.

Referring now to FIG. 10, each pair of mated micro-ferrules 60 is configured to be placed in a holder 102 that is configured to maintain the mating condition between the two micro-ferrules 60 across the connection joint 62. The holder 102, including the mated micro-ferrules 60, may form a mated ferrule assembly 106. The holders 102 are configured to be located in a cabinet, closure, or other terminal, for example, where optical connections between micro-cable assemblies 42 are made. As shown, each holder 102 includes a body 108 having a channel 110 that extends from a first end 112 to a second end 114 of the body 108. The channel 110 is configured to receive the pair of mated micro-ferrules 60, as shown. In that regard, the connection joint 62 between the micro-ferrules 60 may be generally centrally located within the channel 110. Located at each end 112, 114 of the body 108 of the holder 102 is a spring clip 116 that is configured to bias each micro-ferrule 60 in a direction into the channel 110.

With continued reference to FIG. 10, each spring clip 116 extends from the body 108 to a terminal end 118 that includes a notch 120 that forms a pair of spring arms 122 that are configured to engage the rear surface 84 of the body 80 of the micro-ferrule 60 to bias the micro-ferrule 60 into the channel 110. The optical fibers 50, including the subunit sheath 58 (not shown), are configured to be received through the notch 120. The pair of spring clips 116 work together to bias the pair of micro-ferrules 60 into engagement at the connection joint 62 to thereby maintain the mating condition. In the embodiment shown, each micro-ferrule 60 may have a length (i.e., a distance between the front surface 82 and the rear surface 84) of approximately 6 millimeters. The mated ferrule assembly 106 may a length of approximately 15 millimeters and a width of approximately 4 millimeters.

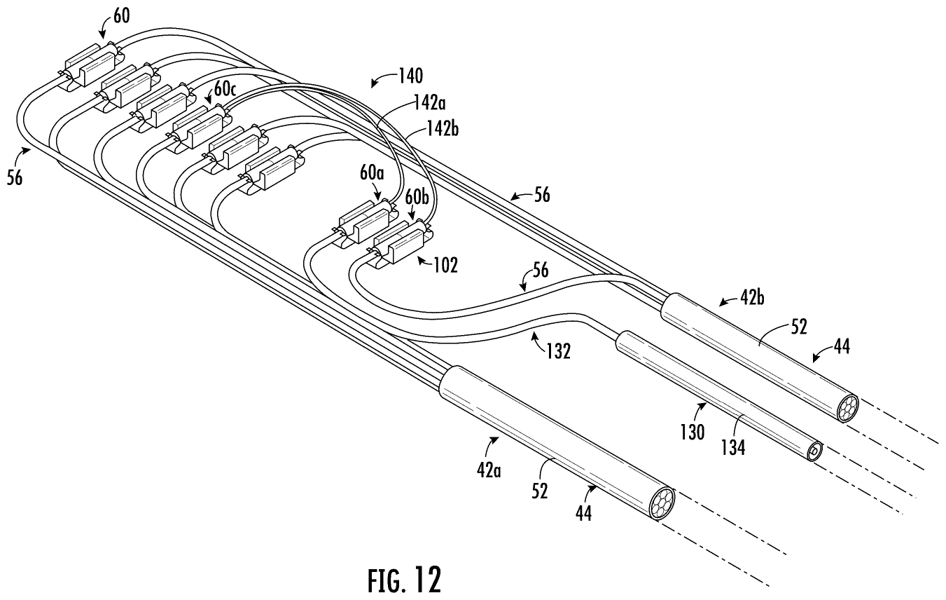

FIG. 11 is a perspective view of a first pre-terminated micro-cable assembly 42a and a second pre-terminated micro-cable assembly 42b connected together, such as within a terminal, for example, and further including at least one drop cable 130. The first and second micro-cable assemblies 42a, 42b may be representative of distribution cables 20, as shown in FIG. 1, for example. To that end, the drop cable 130 may be representative of a drop cable 24 shown in FIG. 1, for example. The connection between the first and second micro-cable assemblies 42a, 42b may be made at a remote network access point 22, as shown in FIG. 1, for example.

With continued reference to FIG. 11, the first micro-cable assembly 42a includes six subunits 56 pre-terminated or connectorized with micro-ferrules 60, as described above. The second micro-cable assembly 42b includes five subunits 56 pre-terminated with micro-ferrules 60. As shown, the micro-ferrules 60 of five subunits 56 of the first micro-cable assembly 42a are connected to the five micro-ferrules 60 of the five subunits 56 of the second micro-cable assembly 42b at corresponding connection joints 62. To that end, each mated pair of micro-ferrules 60 are supported within a holder 102 that may be mounted within theterminal at the remote network access point 22, for example.

The drop cable 130 includes a pre-selected number of optical fibers that are arranged within at least one subunit 132 and that have at least one end pre-terminated a micro-ferrule 60. Like the micro-cable assemblies 42a, 42b, the subunit 132 may be received within a main cable sheath 134, as shown. The micro-ferrule 60 at one end of the drop cable 130 may be connected to the micro-ferrule 60 of any one of the subunits 56 of the first micro-cable assembly 42a to connect the fiber optic network 10 to one or more premises, such as the MDU 26 shown in FIG. 2, for example. In one embodiment, all the optical fibers 50 of the subunit 56 of the first micro-cable assembly 42a (e.g., 24 optical fibers 50) may be connected to optical fibers 50 in the drop cable 130 at the connection joint 62. To that end, the mated pair of micro-ferrules 60 may be supported within a holder 102 that may be mounted within the terminal at the remote network access point 22. The drop cable 130 may have a diameter that is smaller compared to the diameter of the micro-cable assemblies 42a, 42b. For example, a drop cable 130 having only a single subunit 132 may be routed through microduct as small as 3 millimeters in diameter.

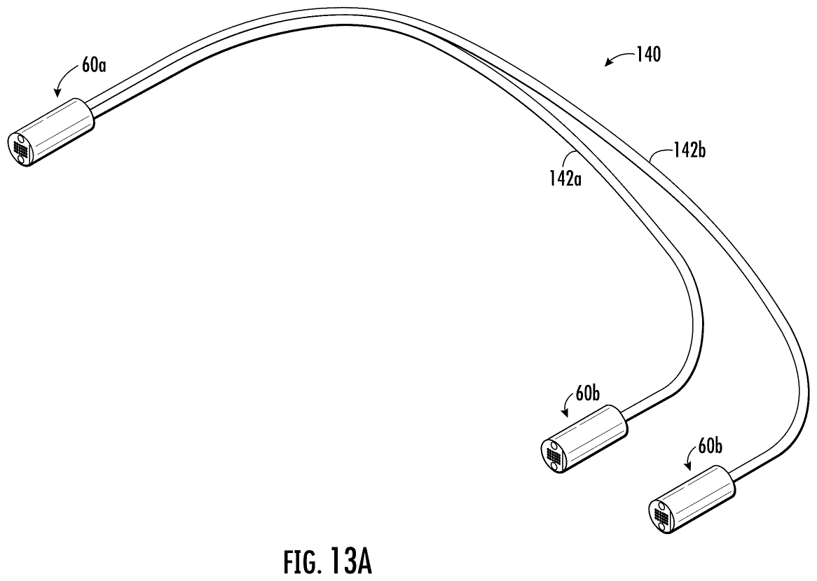

FIG. 12 is a perspective view illustrating the first and the second micro-cable assemblies 42a, 42b connected together, and further including at least one breakout harness 140 in accordance with an embodiment of the disclosure. The breakout harness 140 includes two breakout cables 142a, 142b, with one breakout cable 142a being connected to the drop cable 130 and the other breakout cable 142b being connected to the second micro-cable assembly 42b. In that regard, the breakout harness 140 is used to configure the number of drop optical fibers being terminated to one or more premises and the number of pass-through optical fibers that are to be connected to downstream premises. Thus, only a portion of the optical fibers 50 of the subunit 56 of the first micro-cable assembly 42a to which the breakout harness 140 is connected may be connected to optical fibers 50 in the drop cable 130 via the first breakout cable 142a. A remainder of the optical fibers 50 of the subunit 56 of the first micro-cable assembly 42a to which the breakout harness 140 is connected may be connected to optical fibers 50 of the subunit 56 of the second micro-cable assembly 42b via the second breakout cable 142b. As shown, optical connections made between the breakout harness 140 and the first and second micro-cable assemblies 42a, 42b and the drop cable 130 may be supported within a holder 102. The ability to switch out a breakout harness 140 provides for easy reconfiguration of the number of optical fibers 50 being connected to the drop cable 130.

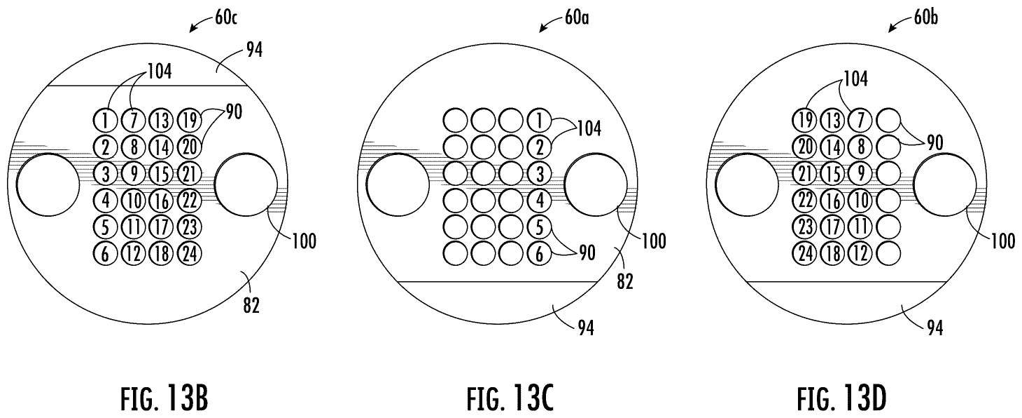

With reference to FIGS. 13A-13D, additional details of the breakout harness 140 will now be described. As shown in FIG. 13A, the breakout harness 140 includes an input micro-ferrule 60c to which the two breakout cables 142a, 142b are connected. Each breakout cable 142a, 142b includes an output micro-ferrule 60a, 60b, respectively. The input and output micro-ferrules 60a, 60b, 60c may have a same construction as the micro-ferrules 60 described above with respect to FIGS. 3-12, for example, and like reference numerals are used in the figures to represent like features. However, the output micro-ferrules 60a, 60b may only be partially populated with optical fibers 50, as described in further detail below.

FIG. 13B shows the front surface 82 of the input micro-ferrule 60c of the breakout harness 140. As shown, the input micro-ferrule 60c includes 24 optical fibers 50, as indicated by the fiber numbers 104. Thus, all the optical fibers 50 of the subunit 56 of the first micro-cable assembly 42a are configured to be connected to optical fibers 50 in the breakout harness 140 via the input micro-ferrule 60c. The input micro-ferrule 60c includes a key-up polarity configuration, as shown. FIG. 13C shows the front surface 82 of the output micro-ferrule 60a of the first breakout cable 142a that is configured to be connected to the drop cable 130. As shown, the output micro-ferrule 60a includes six drop optical fibers, as indicated by the fiber numbers 104. Thus, the breakout harness 140 is configured such that only six optical fibers are being separated out for connection to the drop cable 130. Therefore, the first breakout cable 142a may only include six optical fibers. The remaining eighteen pass-through optical fibers are configured to be connected to the subunit 56 of the second micro-cable assembly 42b via the output micro-ferrule 60b of the second breakout cable 142b. To that end, FIG. 13D shows the front surface 82 of the out micro-ferrule 60b of the second breakout cable 142b having 18 optical fibers, as indicated by the fiber numbers 104. As shown, the output micro-ferrules 60a, 60b each include a key-down polarity configuration.

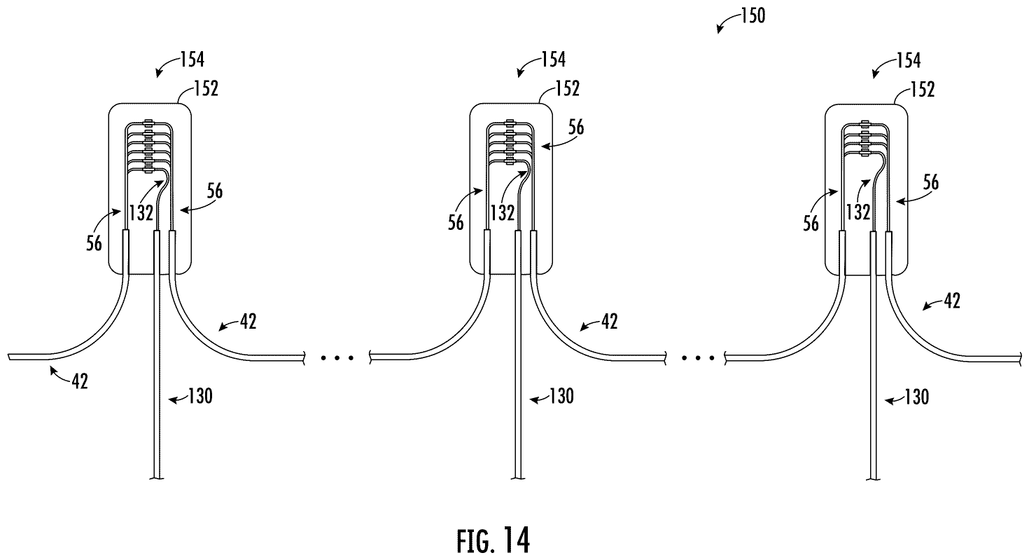

FIG. 14 is a schematic view of a multi-drop pre-connectorized micro-cable distribution network 150 having pre-terminated micro-cable assemblies 42 in accordance with an embodiment of the disclosure. In that regard, FIG. 14 illustrates at least two micro-cable assemblies 42 being connected within a terminal 152 at a drop point 154, such as a remote network access point 22, for example. One or more drop cables 130 extend from each terminal 152. The drop cables 130 may or may not be connected to each micro-cable assembly 42 with a breakout harness 140, as described above. The length of each micro-cable assembly 42 may be predetermined based on a measured distance between drop points 154, for example. As shown, some pass-through optical fibers may experience multiple micro-ferrule 60 connections. However, the increase in average insertion loss is expected to be less than 1 dB for the longest cable runs. As a result of the arrangement and size of the micro-ferrules 60, the micro-cables assemblies 42 may be routed to (via microduct) and connected in terminals 152 that are less than 76 millimeters (3 inches) wide and 152 millimeters (6 inches) long. The staggered arrangement of the micro-ferrules 60 of each micro-cable assembly 42 allows for simple organization of the cable subunits 56 and micro-ferrules 60 within the terminals 152, as shown.

FIGS. 15A-20B depict micro-ferrules 60 having non-round cross-sectional profiles or features that are suitable for use with cable assemblies 42 disclosed herein. In particular, these micro-ferrules 60 are suitably small for installation within a small micro-duct. By way of explanation, these micro-ferrules 60 are suitable for use in micro-ducts having a diameter of about 4 millimeters that are terminated on a suitable cable assembly 42 for fitting within the space of the micro-duct. Specifically, FIG. 15A to FIG. 20B depict micro-ferrules 60 suitable for use in a micro-duct 300 having an inner diameter of 4 millimeters. The micro-duct 300 is represented by the circular profile in certain FIGS. showing the profile of the micro-ferrule 60 within the circular profile of the micro-duct 300.

FIG. 15A depicts a profile of micro-ferrule 60 having a 2D array according to the concepts disclosed suitable for being disposed in micro-duct 300 along with a perspective view of the front end 82 of the micro-ferrule 60 in FIG. 15B. As shown, this micro-ferrule 60 has a generally oval profile. As shown, this micro-ferrule 60 has a maximum cross-sectional dimension D of 2.6 millimeters or less that is shown within the micro-duct 300 having an inner diameter of 4 millimeters. This micro-ferrule 60 has a 2D array of two rows of bores 60 with each row having six bores 90. However, this micro-ferrule 60 may have other 2D arrays as desired.

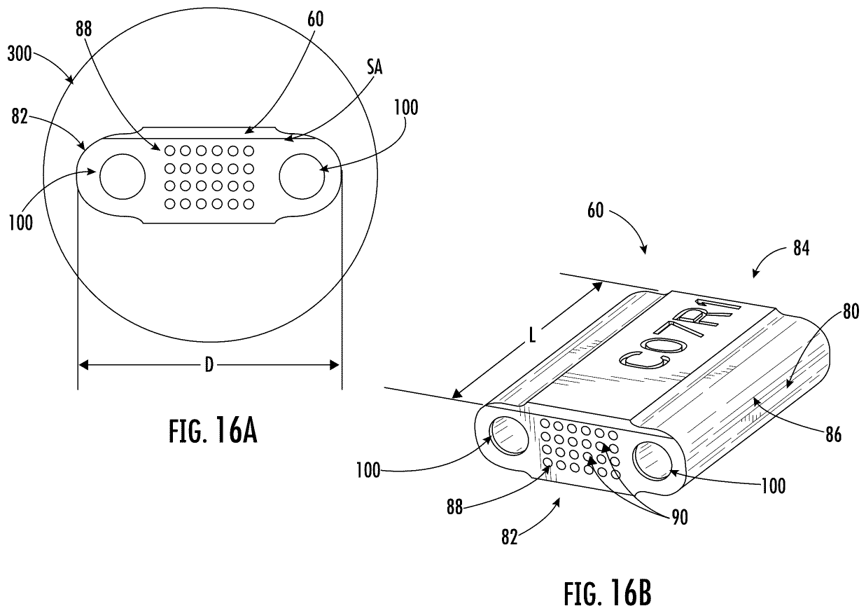

FIGS. 16A and 16B depict a profile of still another micro-ferrule 60 that is similar to the micro-ferrule 60 of FIGS. 15A and 15B with FIG. 15A disposed in micro-duct 300 along with perspective view of the front end 82 of the micro-ferrule 60 of FIG. 16B. This micro-ferrule has ends with reduced vertical dimensions about the mating bores 100, thereby allowing a smaller size for the cable assembly 42 within the micro-duct 300. This micro-ferrule 60 has a 2D array of four rows of bores 60 with each row having six bores 90 for a total of 24 bores 90. Again, this micro-ferrule 60 may have other 2D arrays as desired.

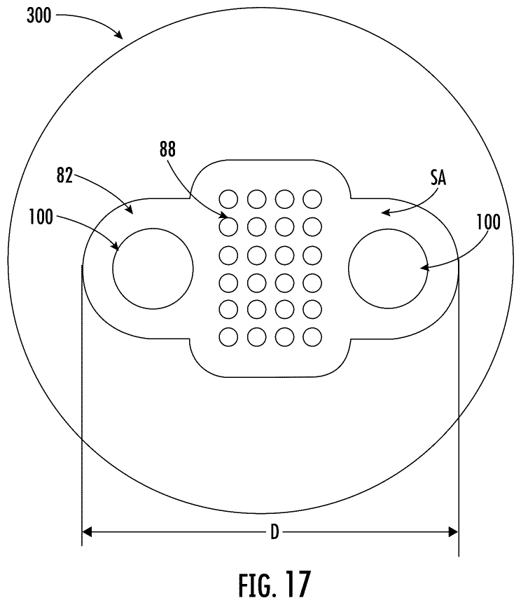

FIG. 17 depicts a profile of yet another micro-ferrule 60 that is similar to the disposed in a duct. This micro-ferrule 60 has a 2D array of six rows of bores 60 with each row having four bores 90 for a total of 24 bores 90. Additionally, this micro-ferrule 60 has a taller profile compared with the micro-ferrule 60 of FIGS. 16A and 16B for making a more compact profile for use in the micro-duct 300. This micro-ferrule 60 has ends with reduced vertical dimensions about the mating bores 100 as well, thereby allowing a smaller size for the cable assembly 42 within the micro-duct 300.

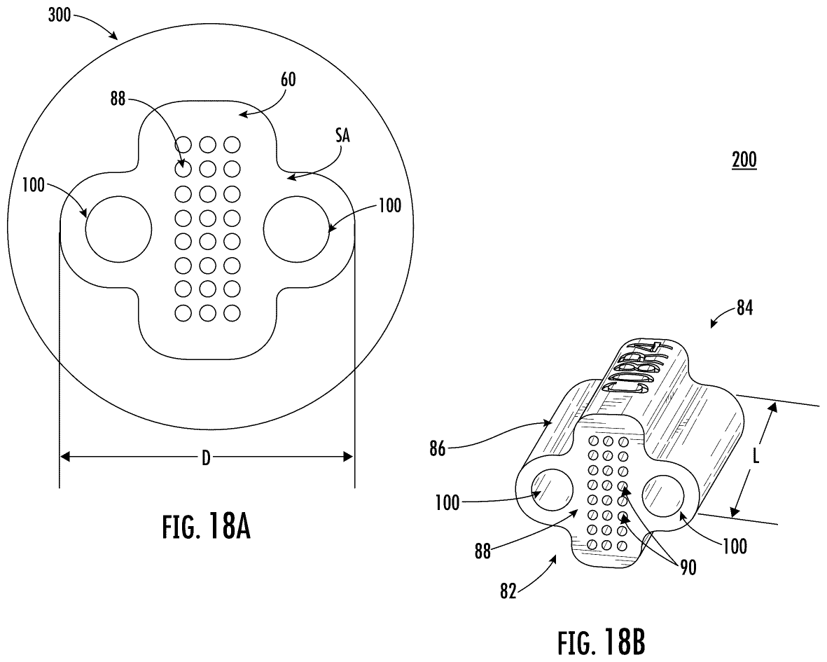

FIG. 18A depicts a profile of a further micro-ferrule 60 suitable for micro-ducts 300 along with a perspective view of the front end 82 of the micro-ferrule 60 in FIG. 18B that is similar to the micro-ferrule 60 of FIG. 17. This micro-ferrule 60 has a 2D array of eight rows of bores 60 with each row having three bores 90 for a total of 24 bores 90. Additionally, this micro-ferrule 60 has a taller profile compared with the micro-ferrule 60 of FIG. 17 for making a more compact profile for use in the micro-duct 300. This micro-ferrule 60 has ends with reduced vertical dimensions about the mating bores 100 as well, thereby allowing a smaller size for the cable assembly 42 within the micro-duct 300.

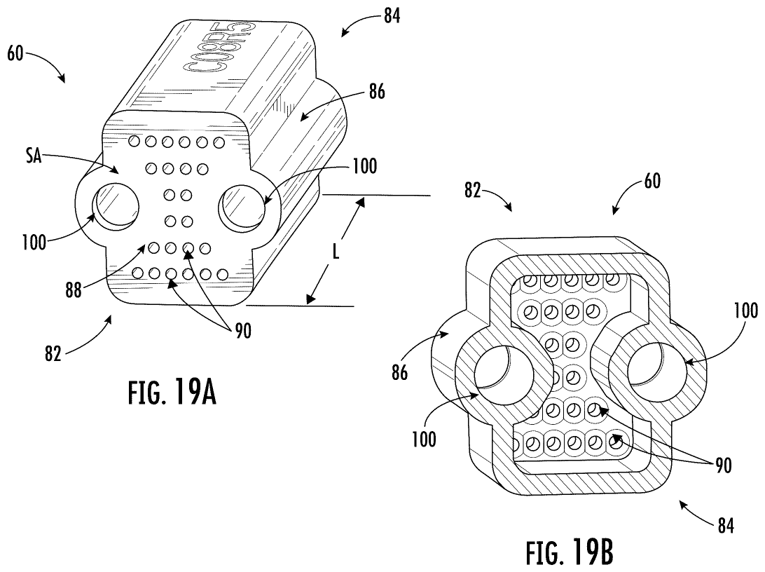

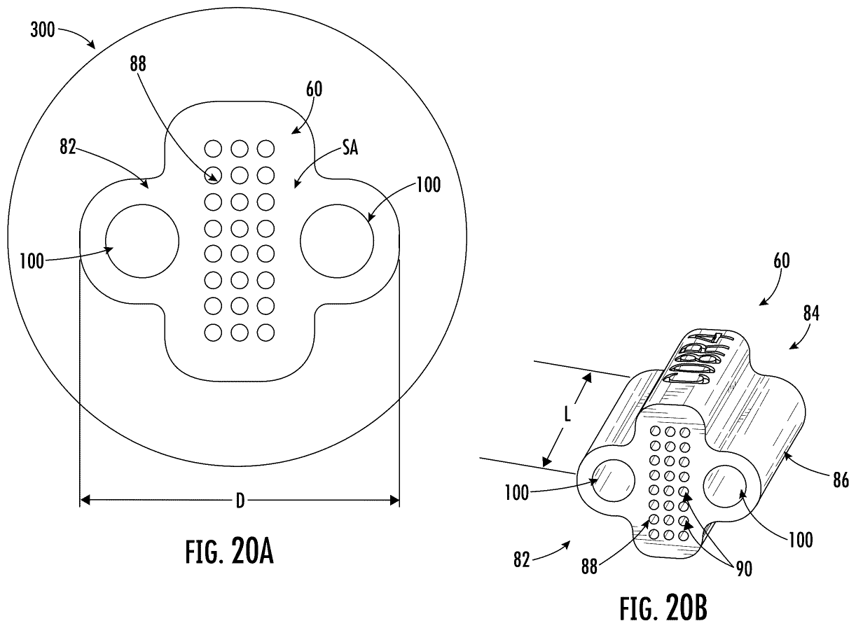

FIGS. 19A and 19B depict front and rear perspective views of another profile for a micro-ferrule 60 having a different number of bores in one or more rows of the array of fiber bores. This micro-ferrule 60 in FIGS. 19A and 19B is similar to the micro-ferrule 60 of FIGS. 18A and 18B. This micro-ferrule 60 has a 2D array of six rows of bores 60 with the rows having at least one adjacent row with a different number of bores 90 for a total of 24 bores 90. Additionally, this micro-ferrule 60 has a compact profile for use in the micro-duct 300. This micro-ferrule 60 allows the mating bores 100 to move closer together for allowing a smaller size. FIGS. 20A and 20B depict a profile of still another micro-ferrule 60 according to the concepts disclosed.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A pre-terminated micro-cable assembly, comprising:
a main cable; and
one or more subunits each including a pre-selected number of optical fibers arranged within the main cable, each of the one or more subunits each having a first end terminated with a micro-ferrule, the micro-ferrule comprising a plurality of microholes arranged in a 2D array pattern for receiving and terminating a plurality of the pre-selected number of optical fibers and with the micro-ferrule comprising a maximum cross-sectional dimension of less than or equal to 2.6 millimeters with at least two mating features having a diameter of less than or equal to 0.60 millimeters arranged on opposite sides of the 2D array pattern, wherein the 2D array pattern comprises a pitch less than or equal to 200 micrometers (μm), thereby enabling installation of the micro-ferrule into micro-ducts.

2. The pre-terminated micro-cable assembly of claim 1, wherein the 2D array pattern of microholes comprises at least two-rows or at least two columns.

3. The pre-terminated micro-cable assembly of claim 1, wherein the 2D array pattern of microholes comprises at least four-rows or at least four columns.

4. The pre-terminated micro-cable assembly of claim 1, the micro-ferrule comprising a front mating surface having a surface area of 4 square millimeters or less.

5. The pre-terminated micro-cable assembly of claim 1, wherein each micro-ferrule terminates at least 24 optical fibers.

6. The pre-terminated micro-cable assembly of claim 1, wherein the micro-ferrules of the one or more subunits at a first end of the pre-terminated micro-cable assembly are spaced apart in a staggered arrangement along a first end section of the pre-terminated micro-cable assembly.

7. The pre-terminated micro-cable assembly of claim 6, wherein each of the one or more subunits have a second end terminated with a respective micro-ferrule, and wherein the micro-ferrules of the one or more subunits at a second end of the pre-terminated micro-cable assembly are spaced apart in a staggered arrangement along a second end section of the pre-terminated micro-cable assembly.

8. The pre-terminated micro-cable assembly of claim 7, wherein each micro-ferrule at the first end of the one or more subunits includes a key-up polarity, and each micro-ferrule at the second end of the one or more subunits includes a key-down polarity.

9. The pre-terminated micro-cable assembly of claim 1, wherein a total optical fiber count of the pre-terminated micro-cable assembly is at least 48 optical fibers.

10. The pre-terminated micro-cable assembly of claim 1, wherein a maximum dimension of each micro-ferrule is approximately 2.6 millimeters or less.

11. The pre-terminated micro-cable assembly of claim 1, wherein a maximum diameter of pre-terminated micro-cable assembly is approximately 6.3 millimeters or less.

12. The pre-terminated micro-cable assembly of claim 1, further comprising an installation grip.

13. The pre-terminated micro-cable assembly of claim 12, wherein a diameter of the installation grip is no more than an outer diameter of the pre-terminated micro-cable assembly.

14. The pre-terminated micro-cable assembly of claim 12, wherein each micro-ferrule at the first end of the one or more subunits is located within the installation grip.

15. The pre-terminated micro-cable assembly of claim 1 being a portion of a micro-cable distribution network.

16. A micro-ferrule configured to terminate a plurality of optical fibers, the micro-ferrule comprising:
a ferrule body that extends between a front surface and a rear surface with the ferrule body comprising a front mating surface that includes a plurality of microholes arranged in a 2D array pattern for receiving and terminating a plurality of optical fibers and the micro-ferrule comprising a maximum cross-sectional dimension of less than or equal to 2.6 millimeters and at least two mating features having a diameter less than or equal to 0.60 millimeters arranged on opposite sides of the 2D array pattern, wherein the 2D array pattern comprises a pitch of less than or equal to 200 micrometers (μm), thereby enabling installation of the micro-ferrule into suitable micro-ducts.

17. The micro-ferrule of claim 16, wherein the plurality of optical fibers being terminated comprises at least 24 optical fibers.

18. The micro-ferrule of claim 16, the micro-ferrule comprising a front mating surface having a surface area of 4 square millimeters or less.

19. The micro-ferrule of claim 16, wherein wherein the 2D array pattern of microholes comprises at least two-rows or at least two columns.

20. The micro-ferrule of claim 16, wherein wherein the 2D array pattern of microholes comprises at least four-rows or at least four columns.

21. The micro-ferrule of claim 16, wherein the at least two mating features comprise one or more of a guide hole or a guide pin.

22. The micro-ferrule of claim 21, wherein the guide pin has a diameter less than 0.60 millimeters.

23. The micro-ferrule of claim 16, wherein the ferrule body includes a polarity marker.

24. The micro-ferrule of claim 16, wherein the front surface is angled relative to a plane orthogonal to the longitudinal axis of the ferrule body.

25. The micro-ferrule claim 24, wherein the front surface is angled approximately 8° to the plane orthogonal to the longitudinal axis.

26. The micro-ferrule of claim 16, wherein each microhole of the plurality of microholes includes a lead-in feature.

27. The micro-ferrule of claim 16, wherein the plurality of microholes are arranged in a 6×4 array.

28. A micro-ferrule configured to terminate at least one optical fiber, the micro-ferrule comprising:
a ferrule body that extends between a front surface and a rear surface and the ferrule body is configured for receiving at least one optical fiber with the ferrule body having a front mating surface that includes at least one microhole arranged in a 1D array pattern and the micro-ferrule comprising a maximum cross-sectional dimension of less than or equal to 2.6 millimeters and at least two mating features having a diameter less than or equal to 0.60 millimeters arranged on opposite sides of the 1D array pattern.

29. The micro-ferrule of claim 28, wherein the 1D array pattern comprising a pitch of less than or equal to 200 micrometers (μm).
